(19) United States
(12) Patent Application Publication
(10) Pub. No.: US 2006/0108567 A1
(43) Pub. Date: May 25, 2006

(54) Conductive poly (arylene ether) compositions and methods of making the same

(76) Inventors: Sanjay Gurbasappa Charati, Bangalore (IN); Yogendrasinh Bharatsinh Chauhan, Valsad (IN); Adil Minoo Dhalla, Mumbai (IN); Soumyadeb Ghosh, Bangalore (IN); Parnasree Maiti, Midnapore (IN); Nitin Mutha, Nashik (IN); Nisha Preschilla, Bangalore (IN)

Correspondence Address: CANTOR COLBURN, LLP, 55 GRIFFIN ROAD SOUTH, BLOOMFIELD, CT, 06002, US

(21) Appl. No.: 11/291,047

(22) Filed: Nov. 30, 2005

Related U.S. Application Data
(63) Continuation-in-part of application No. 10/248,702, filed on Feb. 11, 2003.
(60) Provisional application No. 60/319,419, filed on Jul. 23, 2002.

(51) Int. Cl. H01B 1/12

(52) U.S. Cl. 252/500

(57) ABSTRACT

A resin composition comprises a poly(arylene ether); a polyamide; an impact modifier; an electrically conductive filler; and an additive having greater than or equal to four conjugated double bonds and a melting temperature less than or equal to 400° C.

### CROSS REFERENCE TO RELATED APPLICATIONS

This application is a continuation-in-part application of U.S. patent application Ser. No. 10/248,702 filed Feb. 11, 2003 claiming the benefit of U.S. Provisional Patent Application Ser. No. 60/319,419 filed Jul. 23, 2002, which are each fully incorporated herein by reference.

### BACKGROUND OF THE INVENTION

This disclosure relates to poly(arylene ether) compositions, and in particular to conductive poly(arylene ether) blends.

Poly(arylene ether) resins, such as polyphenylene ether resins (PPE), are an extremely useful class of high performance engineering thermoplastics by reason of their hydrolytic stability, high dimensional stability, toughness, heat resistance, and dielectric properties. This unique combination of properties renders poly(arylene ether) based compositions, particularly poly(arylene ether)/polyamide blends, suitable for a broad range of applications which are well known in the art. For example, poly(arylene ether) blends are being widely used in the fields of automobile parts, electric parts, office devices, and the like. In some of these various applications, the poly(arylene ether) blends are made electrically conductive by the addition of an electrically conductive filler, such as graphite powder and/or carbon black powder, to the resin composition.

Due to the high loadings of conductive fillers used in the resin compositions, a decrease in moldability and degraded mechanical properties, including poor elongation and reduced impact strength, is often observed.

Accordingly, a continuing need exists in the art for conductive poly(arylene ether) blend compositions with enhanced electrical properties without a significant reduction in mechanical properties.

### BRIEF DESCRIPTION OF THE INVENTION

The needs discussed above have been satisfied by a resin composition comprising:

a poly(arylene ether);

a polyamide or polyester;

an impact modifier;

an electrically conductive filler; and

an additive having greater than or equal to four conjugated double bonds and a melting temperature less than or equal to 400° C.

A method for preparing the compositions and articles made from the composition are also provided.

### DETAILED DESCRIPTION OF THE INVENTION

In this specification and in the claims, which follow, reference will be made to a number of terms which shall be defined to have the following meanings.

The singular forms “a,” “an,” and “the” include plural referents unless the context clearly dictates otherwise.

“Optional” or “optionally” means that the subsequently described event or circumstance may or may not occur, and that the description includes instances where the event occurs and instances where it does not.

“Combination” as used herein includes mixtures, copolymers, reaction products, blends, composites, and the like.

Furthermore, the endpoints of all ranges reciting the same characteristic are independently combinable and inclusive of the recited endpoint.

It has been unexpectedly found that inclusion of an additive having greater than or equal to four conjugated double bonds and a melting temperature less than or equal to 400° C. to a poly(arylene ether) composition comprising a conductive filler results in a composition having enhanced electrical conductivity and a negligible effect on the mechanical properties when compared to a similar composition lacking the additive. Further, in other embodiments, a poly(arylene ether) composition comprising the additive compound can achieve a comparable conductivity using lower conductive filler levels than conductive poly(arylene ether) composition without the additive, resulting in improved mechanical properties of the composition. In yet other embodiments, improvements in heat resistance, and a lowering in thermal expansion can be realized compared to a conductive poly(arylene ether) composition without the additive.

Specific volume resistivity (SVR) is defined as the electrical resistance through a one-centimeter cube of material and is expressed in ohm-cm. The lower the specific volume resistivity of a material, the more conductive the material is. In some embodiments the composition has a specific volume resistivity less than or equal to 10¹² ohm-cm. In one embodiment the composition has a specific volume resistivity less than or equal to 10⁶ ohm-cm, or, more specifically, less than or equal to 10⁵ ohm- cm, or, even more specifically, less than or equal to 10⁴ ohm-cm. In one embodiment the composition has a specific volume resistivity greater than or equal to 10 ohm-cm, or, more specifically, greater than or equal to 10² ohm-cm, or, even more specifically, greater than or equal to 10³ ohm-cm. Specific volume resistivity may be determined as described in the Examples.

In one embodiment, the notched Izod Impact of the composition at room temperature (22° C. to 23° C.) is greater than or equal to 17 kilojoules per square meter (kJ/m²), or, more specifically, greater than or to 25 kJ/m², or, even more specifically, greater than or equal to 40 kJ/m² as tested in accordance with ISO 180/1A at 23° C. using specimen type 1 and notch type A. The dimensions of specimen type 1 are 80 millimeters (mm) long, 10 mm wide and 4 mm thick. Notch depth is 2 mm. A 5.5 Joule (J) hammer weight was allowed to freely fall to break the notched samples with the notch facing the hammer. The maximum limit for the impact energy can be as high as 170 kJ/m2 at 23° C., which is when sample is not broken at 5.5 J hammer impact.

In one embodiment, the composition has a coefficient of thermal expansion (CTE) of 3×10⁻⁵ mm/mm/° C. (millimeter per millimeter per degree Celsius) to 10×10⁻⁵ mm/mm/° C., or, more specifically, 4×10⁻⁵ mm/mm/° C. to 8×10-mm/mm/° C., or, even more specifically, 5×10⁻⁵ mm/mm/° C. to 7×10⁻⁵ mm/mm/° C. Thermal expansion coefficient (CTE) measuring procedure complies with ISO 11359-2 with the use of Thermal Mechanical Analyzer (TMA). The sample is annealed below the softening temperature of the poly(arylene ether) (about 30 degrees below glass transition temperature of the PPE) in the first heating cycle and the expansion is recorded in the second heating cycle. Sample dimensions for the measurement are 9 mm×9 mm×4 mm ±1 mm. The measurements are performed along in-flow direction along the direction the melt flows inside the mold cavity during molding. The temperature is 23° C. to 60° C. for the CTE measurement.

In one embodiment, the composition has a melt index of greater than or equal to 6 grams per 10 minutes (g/10 min), or, more specifically, greater than or equal to 7 (g/10 min), or, even more specifically, greater than or equal to 8 (g/10 min), wherein the melt index is measured by ISO 1.133, Procedure at 280° C. and 5 kilogram load. Moreover, in one embodiment, the composition comprises a melt index of 4 (g/10 min) to 7 (g/10 min), more specifically 4.5 to 6 (g/10 min).

The composition comprises A) a poly(arylene ether), B) a polyamide or polyester, C) an impact modifier, D) an electrically conductive filler, and E) an additive having greater than or equal to four conjugated double bonds and a melting temperature less than or equal to 400° C.

In various other embodiments, the composition can further comprise reinforcing fillers and secondary additives as discussed below.

As used herein, a “poly(arylene ether)” comprises a plurality of structural units of the formula (I): 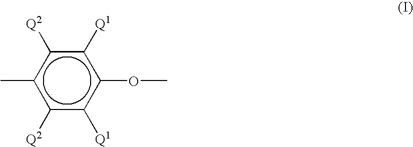
wherein for each structural unit, each Q¹ and Q² is independently hydrogen, halogen, primary or secondary lower alkyl (e.g., an alkyl containing 1 to 7 carbon atoms), phenyl, haloalkyl, aminoalkyl, alkenylalkyl, alkynylalkyl, hydrocarbonoxy, aryl and halohydrocarbonoxy, wherein at least two carbon atoms separate the halogen and oxygen atoms. In some embodiments, each Q¹ is independently alkyl or phenyl, for example, C₁₋₄ alkyl, and each Q² is independently hydrogen or methyl. The poly(arylene ether) can comprise molecules having aminoalkyl-containing end group(s), typically located in an ortho position to the hydroxy group. Also frequently present are tetramethyldiphenoquinone (TMDQ) end groups, typically obtained from reaction mixtures in which tetramethyldiphenoquinone by-product is present.

The poly(arylene ether) can be in the form of a homopolymer; a copolymer; a graft copolymer; an ionomer; or a block copolymer; as well as combinations comprising at least one of the foregoing. For example, in one embodiment, poly(arylene ether) includes polyphenylene ether (PPE) comprising 2,6-dimethyl-1,4-phenylene ether units optionally in combination with 2,3,6-trimethyl-1,4-phenylene ether units.

The poly(arylene ether) can be prepared by the oxidative coupling of monohydroxyaromatic compound(s) such as 2,6-xylenol and 2,3,6-trimethylphenol. Catalyst systems are generally employed for such coupling; they can contain heavy metal compound(s) such as a copper, manganese or cobalt compound, usually in combination with various other materials such as a secondary amine, tertiary amine, halide or combinations of two or more of the foregoing.

The poly(arylene ether) can be functionalized with a polyfunctional compound such as a polycarboxylic acid or those compounds having in the molecule both (a) a carbon-carbon double bond or a carbon-carbon triple bond and b) at least one carboxylic acid, anhydride, amide, ester, imide, amino, epoxy, orthoester, or hydroxy group. Examples of such polyfunctional compounds include maleic acid, maleic anhydride, fumaric acid, and citric acid.

The poly(arylene ether) can have a number average molecular weight of 3,000 grams per mole (g/mol) to 40,000 g/mol and a weight average molecular weight of 5,000 g/mol to 80,000 g/mol, as determined by gel permeation chromatography using monodisperse polystyrene standards, a styrene divinyl benzene gel at 40° C. and samples having a concentration of 1 milligram per milliliter of chloroform. The poly(arylene ether) or combination of poly(arylene ether)s has an initial intrinsic viscosity of 0.10 deciliters per gram (dl/g) to 0.60 deciliters per gram (dl/g), as measured in chloroform at 25° C. Initial intrinsic viscosity is defined as the intrinsic viscosity of the poly(arylene ether) prior to melt mixing with the other components of the composition. As understood by one of ordinary skill in the art, the viscosity of the poly(arylene ether) can be up to 30% higher after melt mixing. The percentage of increase can be calculated by (final intrinsic viscosity after melt mixing—initial intrinsic viscosity)/initial intrinsic viscosity. Determining an exact ratio, when two initial intrinsic viscosities are used, will depend somewhat on the exact intrinsic viscosities of the poly(arylene ether) used and the ultimate physical properties that are desired.

The poly(arylene ether) is generally used in amounts of 10 weight percent (wt. %) to 99.5 wt. %. Within this range, the poly(arylene ether) can be used in amounts greater than or equal to 20 wt. %, or, more specifically, greater than or equal to 30 wt. %. Also within this range, the poly(arylene ether) can be used in amounts of less than or equal to 85 wt. %, or, more specifically, less than or equal to 80 wt. %. Weight percent is with respect to the total weight of the composition.

Polyamides, also known as nylons, are characterized by the presence of an amide group (—C(O)NH—), and are described in U.S. Pat. No. 4,970,272. Exemplary polyamides include, but are not limited to, nylon-6; nylon-6,6; nylon-4; nylon-4,6; nylon-12; nylon-6,10; nylon 6,9; nylon-6,12; amorphous polyamide resins; nylon 9T, nylon 6/6T and nylon 6,6/6T with triamine contents below 0.5 weight percent; and combinations comprising at least one of the foregoing polyamides. In one embodiment, the polyamide comprises nylon 6 and nylon 6,6.

Polyamide resins can be obtained by a number of well-known processes such as those described in U.S. Pat. Nos. 2,071,250; 2,071,251; 2,130,523; 2,130,948; 2,241,322; 2,312,966; and 2,512,606. Polyamide resins are commercially available from a wide variety of sources.

Polyamide resins having viscosity of up to 400 milliliter per gram (ml/g) can be used, or, more specifically, having a viscosity of 90 ml/g to 350 ml/g, or, even more specifically, having a viscosity of 110 ml/g to 240 ml/g, as measured in a 0.5 wt. % solution in 96 wt. % sulfuric acid in accordance with ISO 307.

The polyamide is generally used in amounts of 20 wt. % to 90 wt. %. Within this range, the polyamide can be used in an amount greater than or equal to 30 wt. %, or, more specifically, greater than or equal to 40 wt. % of the total weight of the composition. Also within this range, the polyamide can be used in amount less than or equal to 80 wt. %, or, more specifically, less than or equal to 70 wt. %. Weight percent is with respect to the total weight of the composition.

Due to the immiscibility of poly(arylene ether) and polyamide a compatibilizing agent for poly(arylene ether) and polyamide (poly(arylene ether)/polyamide compatibilizing agent) is employed when making the blend. When used herein, the expression “compatibilizing agent” when applied to the poly(arylene ether)/polyamide compatibilizing agent refers to polyfunctional compounds which interact with the poly(arylene ether), the polyamide resin, or both. This interaction between compatibilizing agent and the poly(arylene ether) may be chemical (e.g., grafting) and/or physical (e.g., affecting the surface characteristics of the dispersed phases). In either instance the resulting compatibilized poly(arylene ether)/polyamide composition appears to exhibit improved compatibility, particularly as evidenced by enhanced impact strength, mold knit line strength and/or elongation. As used herein, the expression “compatibilized poly(arylene ether)/polyamide blend” refers to those compositions which have been physically and/or chemically compatibilized with an agent as discussed above, as well as those compositions which are physically compatible without such agents, as taught in U.S. Pat. No. 3,379,792.

Examples of the various poly(arylene ether)/polyamide compatibilizing agents that may be employed include: liquid diene polymers, epoxy compounds, oxidized polyolefin wax, quinones, organosilane compounds, polyfunctional compounds, functionalized poly(arylene ether) and combinations comprising at least one of the foregoing. Poly(arylene ether)/polyamide compatibilizing agents are further described in U.S. Pat. Nos. 5,132,365 and 6,593,411 as well as U.S. Patent Application No. 2003/0166762.

In one embodiment, the poly(arylene ether)/polyamide compatibilizing agent comprises a polyfunctional compound. Polyfunctional compounds which may be employed as a poly(arylene ether)/polyamide compatibilizing agent are of three types. The first type of polyfunctional compounds are those having in the molecule both (a) a carbon-carbon double bond or a carbon-carbon triple bond and (b) at least one carboxylic acid, anhydride, amide, ester, imide, amino, epoxy, orthoester, or hydroxy group. Examples of such polyfunctional compounds include maleic acid; maleic anhydride; fumaric acid; glycidyl acrylate, itaconic acid; aconitic acid; maleimide; maleic hydrazide; reaction products resulting from a diamine and maleic anhydride, maleic acid, fumaric acid, etc.; dichloro maleic anhydride; maleic acid amide; unsaturated dicarboxylic acids (e.g., acrylic acid, butenoic acid, methacrylic acid, t-ethylacrylic acid, pentenoic acid); decenoic acids, undecenoic acids, dodecenoic acids, linoleic acid, etc.); esters, acid amides or anhydrides of the foregoing unsaturated carboxylic acids; unsaturated alcohols (e.g. alkyl alcohol, crotyl alcohol, methyl vinyl carbinol, 4-pentene-1-ol, 1,4-hexadiene-3-ol, 3-butene-1,4-diol, 2,5-dimethyl-3-hexene-2,5-diol and alcohols of the formula CₙH₂ₙ₋₅OH, CₙH₂ₙ₋₇OH and CₙH₂ₙ₋₉OH, wherein n is a positive integer less than or equal to 30); unsaturated amines resulting from replacing from replacing the —OH group(s) of the above unsaturated alcohols with NH₂ groups; functionalized diene polymers and copolymers; and combinations comprising one or more of the foregoing. In one embodiment, the poly(arylene ether)/polyamide compatibilizing agent comprises maleic anhydride and/or fumaric acid.

The second type of polyfunctional poly(arylene ether)/polyamide compatibilizing agents are characterized as having both (a) a group represented by the formula (OR) wherein R is hydrogen or an alkyl, aryl, acyl or carbonyl dioxy group and (b) at least two groups each of which may be the same or different selected from carboxylic acid, acid halide, anhydride, acid halide anhydride, ester, orthoester, amide, imido, amino, and various salts thereof. Typical of this group of compatibilizers are the aliphatic polycarboxylic acids, acid esters and acid amides represented by the formula:
(R^{I}O)ₘR(COOR^{II})ₙ(CONR^{III}R^{IV})ₛ
wherein R is a linear or branched chain, saturated aliphatic hydrocarbon having 2 to 20, or, more specifically, 2 to 10, carbon atoms; R^{I} is hydrogen or an alkyl, aryl, acyl, or carbonyl dioxy group having 1 to 10, or, more specifically, 1 to 6, or, even more specifically, 1 to 4 carbon atoms; each R^{II} is independently hydrogen or an alkyl or aryl group having 1 to 20, or, more specifically, 1 to 10 carbon atoms; each R^{III} and R^{IV} are independently hydrogen or an alkyl or aryl group having 1 to 10, or, more specifically, 1 to 6, or, even more specifically, 1 to 4, carbon atoms; m is equal to 1 and (n+s) is greater than or equal to 2, or, more specifically, equal to 2 or 3, and n and s are each greater than or equal to zero and wherein (OR^{I}) is alpha or beta to a carbonyl group and at least two carbonyl groups are separated by 2 to 6 carbon atoms. Obviously, R^{I}, R^{II}, R^{III}, and R^{IV} cannot be aryl when the respective substituent has less than 6 carbon atoms.

Suitable polycarboxylic acids include, for example, citric acid, malic acid, agaricic acid; including the various commercial forms thereof, such as for example, the anhydrous and hydrated acids; and combinations comprising one or more of the foregoing. In one embodiment, the poly(arylene ether)/polyamide compatibilizing agent comprises citric acid. Illustrative of esters useful herein include, for example, acetyl citrate, mono- and/or distearyl citrates, and the like. Suitable amides useful herein include, for example, N,N′-diethyl citric acid amide; N- phenyl citric acid amide; N-dodecyl citric acid amide; N,N′-didodecyl citric acid amide; and N-dodecyl malic acid. Derivates include the salts thereof, including the salts with amines and the alkali and alkaline metal salts. Exemplary of suitable salts include calcium malate, calcium citrate, potassium malate, and potassium citrate.

The third type of polyfunctional poly(arylene ether)/polyamide compatibilizing agents are characterized as having in the molecule both (a) an acid halide group and (b) at least one carboxylic acid, anhydride, ester, epoxy, orthoester, or amide group, specifically a carboxylic acid or anhydride group. Examples of compatibilizers within this group include trimellitic anhydride acid chloride, chloroformyl succinic anhydride, chloro formyl succinic acid, chloroformyl glutaric anhydride, chloroformyl glutaric acid, chloroacetyl succinic anhydride, chloroacetylsuccinic acid, trimellitic acid chloride, and chloroacetyl glutaric acid. In one embodiment, the poly(arylene ether)/polyamide compatibilizing agent comprises trimellitic anhydride acid chloride.

The foregoing poly(arylene ether)/polyamide compatibilizing agents may be added directly to the melt blend or pre-reacted with either or both of the poly(arylene ether) and polyamide, as well as with other resinous materials employed in the preparation of the composition. With many of the foregoing poly(arylene ether)/polyamide compatibilizing agents, particularly the polyfunctional compounds, even greater improvement in compatibility is found when at least a portion of the poly(arylene ether)/polyamide compatibilizing agent is pre-reacted, either in the melt or in a solution of a suitable solvent, with all or a part of the poly(arylene ether). It is believed that such pre-reacting may cause the poly(arylene ether)/polyamide compatibilizing agent to react with the polymer and, consequently, functionalize the poly(arylene ether). For example, the poly(arylene ether) may be pre-reacted with maleic anhydride to form an anhydride functionalized polyphenylene ether which has improved compatibility with the polyamide compared to a non-functionalized polyphenylene ether.

Where the poly(arylene ether)/polyamide compatibilizing agent is employed in the preparation of the compositions, the amount used will be dependent upon the specific poly(arylene ether)/polyamide compatibilizing agent chosen and the specific polymeric system to which it is added.

The composition further contain one or more agents to improve the impact strength, i.e., an impact modifier. Impact modifiers can be block copolymers containing aryl alkylene repeating units, for example, A-B diblock copolymers and A- B-A triblock copolymers having of one or two aryl alkylene blocks A (blocks having aryl alkylene repeating units), which are typically polystyrene blocks, and a rubber block, B, which is typically an isoprene or butadiene block. The butadiene block may be partially or completely hydrogenated. Mixtures of these diblock and triblock copolymers may also be used as well as mixtures of non-hydrogenated copolymers, partially hydrogenated copolymers, fully hydrogenated copolymers and combinations of two or more of the foregoing.

A-B and A-B-A copolymers include, but are not limited to, polystyrene-polybutadiene, polystyrene-poly(ethylene-propylene), polystyrene- polyisoprene, poly(α-methylstyrene)-polybutadiene, polystyrene-polybutadiene- polystyrene (SBS), polystyrene-poly(ethylene-propylene)-polystyrene, polystyrene- polyisoprene-polystyrene and poly(alpha-methylstyrene)-polybutadiene-poly(alpha- methylstyrene), polystyrene-poly(ethylene-propylene-styrene)-polystyrene, and the like. Mixtures of the aforementioned block copolymers are also useful. Such A-B and A-B-A block copolymers are available commercially from a number of sources, including Phillips Petroleum under the trademark SOLPRENE, Kraton Polymers, under the trademark KRATON, Dexco under the trademark VECTOR, Asahi Kasai under the trademark TUFTEC, Total Petrochemicals under the trademarks FINAPRENE and FINACLEAR and Kuraray under the trademark SEPTON.

In one embodiment, the impact modifier comprises polystyrene- poly(ethylene-butylene)-polystyrene, polystyrene-poly(ethylene-propylene) or a combination of the foregoing.

Another type of impact modifier is essentially free of aryl alkylene repeating units and comprises one or more moieties selected from the group consisting of carboxylic acid, anhydride, epoxy, oxazoline, and orthoester. Essentially free is defined as having aryl alkylene units present in an amount less than 5 weight percent, or, more specifically, less than 3 weight percent, or, even more specifically less than 2 weight percent, based on the total weight of the block copolymer. When the impact modifier comprises a carboxylic acid moiety the carboxylic acid moiety may be neutralized with an ion, specifically a metal ion such as zinc or sodium. It may be an alkylene-alkyl (meth)acrylate copolymer and the alkylene groups may have 2 to 6 carbon atoms and the alkyl group of the alkyl (meth)acrylate may have 1 to 8 carbon atoms. This type of polymer can be prepared by copolymerizing an olefin, for example, ethylene and propylene, with various (meth)acrylate monomers and/or various maleic-based monomers. The term (meth)acrylate refers to both the acrylate as well as the corresponding methacrylate analogue. Included within the term (meth)acrylate monomers are alkyl (meth)acrylate monomers as well as various (meth)acrylate monomers containing at least one of the aforementioned reactive moieties.

In a one embodiment, the copolymer is derived from ethylene, propylene, or mixtures of ethylene and propylene, as the alkylene component; butyl acrylate, hexyl acrylate, or propyl acrylate as well as the corresponding alkyl (methyl)acrylates, for the alkyl (meth)acrylate monomer component, with acrylic acid, maleic anhydride, glycidyl methacrylate or a combination thereof as monomers providing the additional reactive moieties (i.e., carboxylic acid, anhydride, epoxy).

Exemplary first impact modifiers are commercially available from a variety of sources including ELVALOY PTW, SURLYN, and FUSABOND, all of which are available from DuPont.

The aforementioned impact modifiers can be used singly or in combination.

The composition may comprise an impact modifier or a combination of impact modifiers, in an amount of 1 wt. % to 25 wt. %. Within this range, the impact modifier may be present in an amount greater than or equal to 1.5 wt. %, or, more specifically, in an amount greater than or equal to 2 wt. %, or, even more specifically, in an amount greater than or equal to 4 wt. %. Also within this range, the impact modifier may be present in an amount less than or equal to 20 wt. %, or, more specifically, less than or equal to 18 wt. %, or, even more specifically, less than or equal to 15 wt. %. Weight percent is based on a total weight of the composition.

The composition further comprises an electrically conductive filler. Suitable conductive fillers include solid conductive metallic fillers or inorganic fillers coated with a solid metallic filler. These solid conductive metal fillers can be an electrically conductive metal or alloy that does not melt under conditions used when incorporating them into the resin blend, and fabricating finished articles therefrom. Metals such as aluminum, copper, magnesium, chromium, tin, nickel, silver, iron, titanium, and mixtures comprising at least one of the foregoing metals can be incorporated into the polymeric resins as solid metal particles. Physical mixtures and true alloys such as stainless steels, bronzes, and the like, can also serve as metallic constituents of the conductive filler particles. In addition, a few intermetallic chemical compounds such as borides, carbides, and the like, of these metals (e.g., titanium diboride) can also serve as metallic constituents of the conductive filler particles. Solid non-metallic, conductive filler particles such as tin-oxide, indium tin oxide, and the like can also be added to the resin blend. The solid metallic and non- metallic conductive fillers can exist in the form of drawn wires, tubes, nanotubes, flakes, laminates, platelets, ellipsoids, discs, and other commercially available geometries. Specifically, conductive fillers can include carbonaceous fillers such as carbon nanotubes (single-walled and multi-walled), vapor-grown carbon fibers having diameters of 2.5 to 500 nanometers, carbon fibers such as polyacrylonitrile (PAN) carbon fibers, carbon black, graphite, and mixtures comprising at least one of the foregoing fillers.

Various types of conductive carbon fibers can be classified according to their diameter, morphology, and degree of graphitization (morphology and degree of graphitization being interrelated). These characteristics are presently determined by the method used to synthesize the carbon fiber. For example, carbon fibers having diameters of 5 micrometers, and graphene ribbons parallel to the fiber axis (in radial, planar, or circumferential arrangements) are produced commercially by pyrolysis of organic precursors in fibrous form, including phenolics, PAN, or pitch. These types of fibers have a relatively lower degree of graphitization.

Small carbon fibers having diameters of 3 nanometers to 2,000 nanometers, and “tree-ring” or “fishbone” structures, are presently grown from hydrocarbons in the vapor phase, in the presence of particulate metal catalysts at moderate temperatures, i.e., 800° C. to 1,500° C., and thus are commonly known as “vapor-grown carbon fibers”. These carbon fibers are generally cylindrical, and have a hollow core. In the “tree-ring” structure, a multiplicity of substantially graphitic sheets is coaxially arranged about the core, wherein the c-axis of each sheet is substantially perpendicular to the axis of the core. The interlayer correlation is generally low. In the “fishbone” structure, the fibers are characterized by graphite layers extending from the axis of the hollow core, as shown for example in EP 198 558. A quantity of pyrolytically deposited carbon can also be present on the exterior of the fiber. Graphitic or partially graphitic vapor grown carbon fibers having diameters of 3.5 nanometers to 500 nanometers, specifically diameters of 3.5 nanometers to 70 nanometers, or, more specifically, diameters of 3.5 nanometers to 50 nanometers, can be used. Representative vapor grown carbon fibers are described in, for example, U.S. Pat. Nos. 4,565,684; 5,024,818; 4,572,813; 4,663,230; 5,165,909; 4,816,289; 4,876,078; 5,589,152; and 5,591,382.

Carbon nanotubes are fullerene-related structures that consist of graphene cylinders, which can be open or closed at either end with caps containing pentagonal and/or hexagonal rings. Nanotubes can consist of a single wall, or have multiple concentrically arranged walls, and have diameters of 0.7 nanometers to 2.4 nanometers for the single-walled nanotubes and 2 nanometers to 50 nanometers for the multi-walled nanotubes. In the multi-layer structure, the cross-section of the hollow core becomes increasingly small with increasing numbers of layers. At diameters larger than 10 nanometers to 20 nanometers, multi-wall nanotubes begin to exhibit a hexagonal pillar shape, such that the curvature of the nanotubes becomes concentrated at the corners of the pillars. Carbon nanotubes can be produced by laser- evaporation of graphite, carbon arc synthesis, or under low hydrocarbon pressures in the vapor phase. Representative carbon nanotubes are described in U.S. Pat. Nos. 6,183,714; 5,591,312; 5,641,455; 5,830,326; 5,591,832; and 5,919,429.

Carbon black can also be used as the conductive filler. Commercially available carbon blacks include conductive carbon black that is used in modifying the electrostatic dissipation (ESD) properties of the resins. Such carbon blacks are sold under a variety of trade names, including but not limited to S.C.F. (Super Conductive Furnace), E.C.F. (Electric Conductive Furnace), Ketjen Black EC (available from Akzo Co., Ltd.) or acetylene black. Specific carbon blacks are those having average particle sizes less than 200 nanometers, or, more specifically, less than 100 nanometers, or, even more specifically, less than 50 nanometers. Conductive carbon blacks can also have surface areas greater than 100 square meters per gram (m²/g), specifically greater than 400 m²/g, and even more specifically greater than 800 m²/g. Conductive carbon blacks can have a pore volume (dibutyl phthalate absorption) greater than 40 cubic centimeters per hundred grams (cm³/100g), specifically greater than 100 cm³/100g, more specifically greater than 150 cm³/100 g.

Graphite can also be used as the conductive filler. Graphite is a crystalline form of carbon that typically adopts a layered, hexagonal conformation. Graphite is commercially available in powder, flake, exfoliated, expanded, and amorphous forms. Powders can have particle sizes, for example, of 45 micrometers to 150 micrometers. Micronised powders can have particles sizes of 2 micrometers or greater. Graphite flakes can have sizes of 50 micrometers to 600 micrometers.

The conductive fillers are generally present in an amount of 0.25 wt. % to 60 wt. %. Within this range, the conductive fillers can be present in an amount greater than or equal to 0.5 wt. %, or, more specifically greater than or equal to 1.0 wt. %. Also within this range, the conductive fillers can be present in an amount less than or equal to 40 wt. %, or, more specifically less than or equal to 20 wt. %. Weight percent is based on a total weight of the composition.

The composition further comprises an additive having greater than or equal to four conjugated double bonds and a melting temperature less than or equal to 400° C. Without wanting to be bound by theory, the inter-particle electron hopping energy is expected to be lower compared to compositions without the additive, thereby increasing the maximum obtainable conductivity for the composition. Stated another way, lower levels of conductive fillers are needed in the composition in order to achieve a desired level of conductivity. Further, it is believed that synergism between the conductive filler and the additive leads to increased conductivity with a negligible effect on the mechanical properties of the composition.

The additive is one that enhances the electrical conductivity of the conductive composition. Suitable additives include, but are not limited to, polycyclic aromatic compounds and linear conjugated systems. Suitable polycyclic aromatic compounds include, but are not limited to, phthalocyanines, porphyrins, pyrenes, anthracenes, and combinations comprising one or more of the foregoing compounds. Without being held to theory, it is believed that addition of the additive to the composition increases electrical conductivity by either increasing the number of inter- particle contacts or by decreasing the resistance to the electron transfer between the conductive particles. For example, the additive melts during melt processing leading to homogeneous dispersion in the polymer matrix and may also form a coating on the conductive filler, thereby increasing the inter-particle interaction leading to improved conductivity without deterioration of mechanical properties.

Further, without wanting to be bound by theory, the size of the additive can be a factor attributing to the synergy with the conductive filler. Specifically, the additive comprises greater than or equal to four conjugated double bonds. In one embodiment, these at least four conjugated double bonds are carbon-to-carbon double bonds. Moreover, in one embodiment, polycyclic aromatic compounds having relatively smaller structures compared to other polycyclic aromatic compounds can result in greater reductions in conductive filler loading in order to achieve a desired level of conductivity. It is believed that the relatively smaller structures allow for greater contact with the filler particles compared to larger structures.

In one embodiment, the additive can be a phthalocyanine, which is the tetraaza derivative of tetrabenzoporphyrin. Suitable phthalocyanines can be those with or without metal centers. The structure of a substituted phthalocyanine without (II) and with a metal center (III) is shown below:

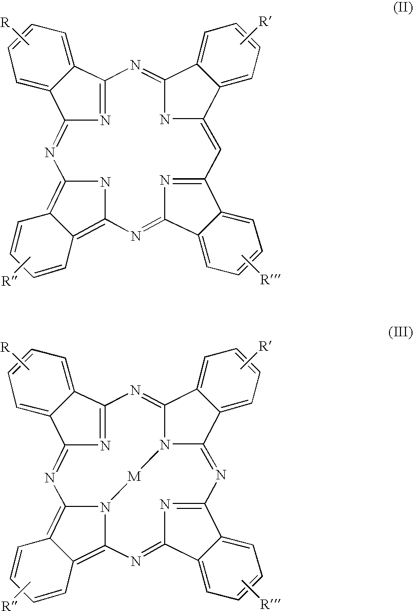

In the case of a phthalocyanine with a metal center, the metal center (M) can be for example, a transition metal, i.e., those metals falling within groups 3-12 of the Periodic Table, which include scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, lanthanum, and the like.

Each R, R′, R″ and R′″ (collectively, “R groups”) can be independently groups such as hydrogen; a halogen atom; an oxygen atom; a sulfur atom; a hydroxyl group; a carbonyl group; a sulfonyl group; a sulfinyl group; an alkyleneoxyalkylene group; a phosphonyl group; a phosphinyl group; an amino group; an imino group; C₁ to C₆ alkyl; C₁ to C₆ alkoxy; aryl; C₁ to C₆ alkyl substituted by at least one of C₁ to C₆ alkyl, C₁ to C₆ alkoxy, or the alkali metal salt of a sulfonate, carboxylate or phosphonate group; C₁ to C₆ alkoxy substituted by at least one of C₁ to C₆ alkyl, C₁ to C₆ alkoxy, or the alkali metal salt of a sulfonate, carboxylate or phosphonate group; and aryl substituted by at least one of C₁ to C₆ alkyl, C₁ to C₆ alkoxy, or the alkali metal salt of a sulfonate, carboxylate or phosphonate group; or two R groups can be taken together to form a six membered aromatic ring in combination with the carbon atoms to which they are attached, said aromatic ring optionally substituted by C₁ to C₆ alkyl, C₁ to C₆ alkoxy, the alkali metal salt of a sulfonate, carboxylate or phosphonate group.

In one embodiment, the additive can be a porphyrin. Porphyrins can be those with or without metal centers. The structure of a substituted porphyrin without (IV) and with a metal center (V) is shown below:

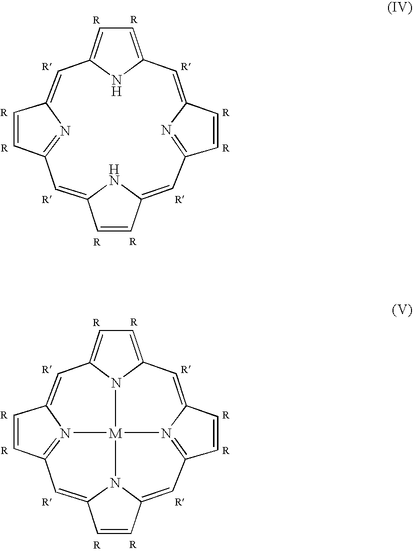

In the case of a porphyrin with a metal center, the metal center (M) can be for example, a “transition metal”, i.e., those metals falling within groups 3-12 of the Periodic Table, which include scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, lanthanum, and the like.

Each R and R′ (collectively, “R groups”) can be independently selected from such groups as hydrogen; a halogen atom; an oxygen atom; a sulfur atom; a hydroxyl group; a carbonyl group; a sulfonyl group; a sulfinyl group; an alkyleneoxyalkylene group; a phosphonyl group; a phosphinyl group; an amino group; an imino group; C₁ to C₆ alkyl; C₁ to C₆ alkoxy; aryl; C₁ to C₆ alkyl substituted by at least one of C₁ to C₆ alkyl, C₁ to C₆ alkoxy, or the alkali metal salt of a sulfonate, carboxylate or phosphonate group; C₁ to C₆ alkoxy substituted by at least one of C₁ to C₆ alkyl, C₁ to C₆ alkoxy, or the alkali metal salt of a sulfonate, carboxylate or phosphonate group; and aryl substituted by at least one of C₁ to C₆ alkyl, C₁ to C₆ alkoxy, or the alkali metal salt of a sulfonate, carboxylate or phosphonate group; or two R groups can be taken together to form a six membered aromatic ring in combination with the carbon atoms to which they are attached, said aromatic ring optionally substituted by C₁ to C₆ alkyl, C₁ to C₆ alkoxy, the alkali metal salt of a sulfonate, carboxylate or phosphonate group.

In one embodiment, the additive can be a pyrene. The structure of a substituted pyrene (VI) is shown below:

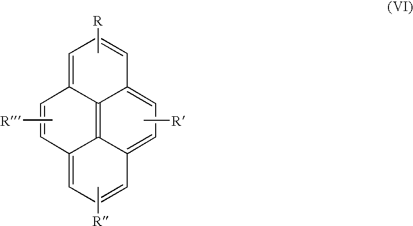

Each R, R′, R″ and R′″ (collectively, “R groups”) can be independently selected from such groups as hydrogen; a halogen atom; an oxygen atom; a sulfur atom; a hydroxyl group; a carbonyl group; a sulfonyl group; a sulfinyl group; an alkyleneoxyalkylene group; a phosphonyl group; a phosphinyl group; an amino group; an imino group; C₁ to C₆ alkyl; C₁ to C₆ alkoxy; aryl; C₁ to C₆ alkyl substituted by at least one of C₁ to C₆ alkyl, C₁ to C₆ alkoxy, or the alkali metal salt of a sulfonate, carboxylate or phosphonate group; C₁ to C₆ alkoxy substituted by at least one of C₁ to C₆ alkyl, C₁ to C₆ alkoxy, or the alkali metal salt of a sulfonate, carboxylate or phosphonate group; and aryl substituted by at least one of C₁ to C₆ alkyl, C₁ to C₆ alkoxy, or the alkali metal salt of a sulfonate, carboxylate or phosphonate group; or two R groups can be taken together to form a six membered aromatic ring in combination with the carbon atoms to which they are attached, said aromatic ring optionally substituted by C₁ to C₆ alkyl, C₁ to C₆ alkoxy, the alkali metal salt of a sulfonate, carboxylate or phosphonate group.

In one embodiment, the additive can be an anthracene. The structure of a substituted anthracene (VII) is shown below:

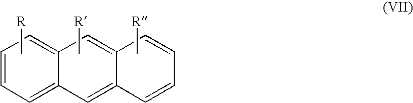

Each R, R′ and R″ (collectively, “R groups”) can be independently selected from such groups as hydrogen; a halogen atom; an oxygen atom; a sulfur atom; a hydroxyl group; a carbonyl group; a sulfonyl group; a sulfinyl group; an alkyleneoxyalkylene group; a phosphonyl group; a phosphinyl group; an amino group; an imino group; C₁ to C₆ alkyl; C₁ to C₆ alkoxy; aryl; C₁ to C₆ alkyl substituted by at least one of C₁ to C₆ alkyl, C₁ to C₆ alkoxy, or the salt of a sulfonate, carboxylate or phosphonate group; C₁ to C₆ alkoxy substituted by at least one of C₁ to C₆ alkyl, C₁ to C₆ alkoxy, or the salt of a sulfonate, carboxylate or phosphonate group; and aryl substituted by at least one of C₁ to C₆ alkyl, C₁ to C₆ alkoxy, or the salt of a sulfonate, carboxylate or phosphonate group; or two R groups can be taken together to form a six membered aromatic ring in combination with the carbon atoms to which they are attached, said aromatic ring optionally substituted by C₁ to C₆ alkyl, C₁ to C₆ alkoxy, the alkali metal salt of a sulfonate, carboxylate or phosphonate group.

The additive having greater than or equal to four conjugated double bonds and a melting temperature less than or equal to 400° C. is generally present in an amount of 0.0025 wt. % to 5 wt. %. Within this range, the additive can be present in an amount greater than or equal to 0.05 wt. %, or, more specifically, greater than or equal to 0.1 wt. %. Also within this range, the additive can be present in an amount less than or equal to 3 wt. %, or, more specifically, less than or equal to 2 wt. %. Weight percent is based on a total weight of the composition. The amount of additive may, in some cases, depend upon the identity of filler. For example, when carbonaceous fibers are used the amount of additive required may be higher than when other fillers such as conductive carbon black. Without being bound by theory it is believed that the additive may be, at least in part, adsorbed by the carbonaceous fibers.

In one embodiment, the composition comprises a polyester. Suitable polyesters include those comprising structural units of the formula (VII): 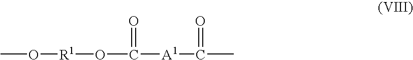
wherein each R¹ is independently a divalent aliphatic, alicyclic or aromatic hydrocarbon radical, or mixtures thereof and each A¹ is independently a divalent aliphatic, alicyclic or aromatic radical, or mixtures thereof. Examples of suitable polyesters comprising the structure of formula (VIII) are poly(alkylene dicarboxylate)s, liquid crystalline polyesters, polyarylates, and polyester copolymers such as copolyestercarbonates and polyesteramides. Also included are polyesters that have been treated with relatively low levels of diepoxy or multi-epoxy compounds. It is also possible to use branched polyesters in which a branching agent, for example, a glycol having three or more hydroxyl groups or a trifunctional or multifunctional carboxylic acid has been incorporated. Treatment of the polyester with a trifunctional or multifunctional epoxy compound, for example, triglycidyl isocyanurate can also be used to make branched polyester. Furthermore, it is sometimes desirable to have various concentrations of acid and hydroxyl endgroups on the polyester, depending on the ultimate end-use of the composition.

When the composition comprises polyester, the composition also comprises a polyester compatibilizer, which is a polymeric compatibilizer. As used herein and throughout, a polymeric compatibilizer is a polymeric polyfunctional compound that interacts with the poly(arylene ether) resin, the polyester resin, or both. This interaction may be chemical (e.g. grafting) and/or physical (e.g. affecting the surface characteristics of the dispersed phases). When the interaction is chemical, the compatibilizer may be partially or completely reacted with the poly(arylene ether) resin, polyester resin or both such that the composition comprises a reaction product. Use of the polymeric compatibilizer can improve the compatibility between the poly(arylene ether) and the polyester, as may be evidenced by enhanced impact strength, mold knit line strength and/or elongation.

Suitable polyester compatibilizers comprise epoxy compounds, and include, but are not limited to, copolymers comprising structural units having pendant epoxy groups. In some embodiments suitable polymeric compatibilizers comprise copolymers comprising structural units derived from at least one monomer comprising a pendant epoxy group and at least one olefinic monomer, wherein the content derived from monomer comprising a pendant epoxy group is greater than or equal to 6 wt %, or, more specifically, greater than or equal to 8 wt %, or, even more specifically greater than or equal to 10 wt %. Illustrative examples of suitable compatibilizers include, but are not limited to, copolymers of glycidyl methacrylate (GMA) with alkenes, copolymers of GMA with alkenes and acrylic esters, copolymers of GMA with alkenes and vinyl acetate. Suitable alkenes comprise ethylene, propylene, and mixtures comprising ethylene and propylene. Suitable acrylic esters comprise alkyl acrylate monomers, including, but not limited to, methyl acrylate, ethyl acrylate, propyl acrylate, butyl acrylate, and combinations of the foregoing alkyl acrylate monomers. When present, said acrylic ester may be used in an amount of 15 wt % to 35 wt % based on the total amount of monomer used in the copolymer. When present, vinyl acetate may be used in an amount of 4 wt % to 10 wt % based on the total amount of monomer used in the copolymer. Illustrative examples of suitable polymeric compatibilizers comprise ethylene-glycidyl acrylate copolymers, ethylene-glycidyl methacrylate copolymers, ethylene-glycidyl methacrylate-vinyl acetate copolymers, ethylene-glycidyl methacrylate-alkyl acrylate copolymers, ethylene-glycidyl methacrylate-methyl acrylate copolymers, ethylene- glycidyl methacrylate-ethyl acrylate copolymers, and ethylene-glycidyl methacrylate- butyl acrylate copolymers.

Suitable polymeric compatibilizers are available from commercial sources, including Sumitomo Chemical Co., Ltd. under the trademarks BONDFAST 2C (also known as IGETABOND 2C; which is a copolymer comprising structural units derived from 94 wt % ethylene, and 6 wt % glycidyl methacrylate); BONDFAST E (also known as IGETABOND E; which is a copolymer comprising structural units derived from 88 wt % ethylene, and 12 wt % glycidyl methacrylate); IGETABOND 2B, 7B, and 20B (which are copolymers comprising structural units derived from 83 wt % ethylene, 5 wt % vinyl acetate, and 12 wt % glycidyl methacrylate); IGETABOND 7M and 20M (which are copolymers comprising structural units derived from 64 wt % ethylene, 30 wt % methyl acrylate, and 6 wt % glycidyl methacrylate); and from Atofina under the trademark LOTADER 8840 (which is a copolymer comprising structural units derived from 92 wt % ethylene, and 8 wt % glycidyl methacrylate); and LOTADER 8900 (which is a copolymer comprising structural units derived from 67 wt % ethylene, 25 wt % methyl acrylate, and 8 wt % glycidyl methacrylate). Mixtures of the aforementioned compatibilizers may also be employed. In one embodiment the compatibilizer is substantially stable at the processing temperature of the final resinous composition.

In various embodiments, the composition can also include effective amounts of at least one secondary additive such as anti-oxidants, flame retardants, drip retardants, dyes, pigments, colorants, stabilizers, small particle mineral fillers such as clay, mica, and talc, antistatic agents, plasticizers, lubricants, glass fibers (long, chopped or milled), and combinations comprising at least one of the foregoing. These secondary additives are known in the art, as are their effective levels and methods of incorporation. Effective amounts of the secondary additives vary widely, but they can be present in a total amount up to 60% or more by weight, of the total weight of the composition. In general, secondary additives such as anti-oxidants, flame retardants, drip retardants, dyes, pigments, colorants, stabilizers, antistatic agents, plasticizers, lubricants, and the like are present in amounts of 0.01 wt. % to 5 wt. % of the total weight of the composition, while small particle mineral fillers and glass fibers comprise 1 wt. % to 60 wt. % of the total weight of the composition.

In one embodiment, specific reinforcing fillers include clay, mica, talc, glass fiber (amino silane coated (6 micrometer diameter and 10-12 millimeters long), carbon fiber (6 micrometer diameter and 6-8 millimeters long), or combinations comprising at least one of the foregoing. These fillers are present in an amount of 2 wt. % to 20 wt. %, specifically 4 wt. % to 15 wt. %, wherein weight percents are based on a total weight of the composition.

The composition can be prepared by melt mixing or a combination of dry blending and melt mixing. Melt mixing can be performed in single or twin screw type extruders or similar mixing devices which can apply a shear to the components.

All of the ingredients may be added initially to the processing system. In some embodiments, the poly(arylene ether) may be precompounded with the compatibilizing agent. Additionally other ingredients such as an impact modifier, additives, and a portion of the polyamide may be precompounded with the compatibilizing agent and poly(arylene ether). In one embodiment, the poly(arylene ether) is precompounded with the compatibilizing agent to form a functionalized poly(arylene ether). The functionalized poly(arylene ether) is then compounded with the other ingredients. In another embodiment the poly(arylene ether), compatibilizing agent, impact modifier, optional additives are compounded to form a first material and the polyamide is then compounded with the first material.

When using an extruder, all or part of the polyamide may be added after melting the poly(arylene ether), e.g., through a port downstream. While separate extruders may be used in the processing, preparations in a single extruder having multiple feed ports along its length to accommodate the addition of the various components simplifies the process. It is often advantageous to apply a vacuum to the melt through one or more vent ports in the extruder to remove volatile impurities in the composition.

The electrically conductive filler may be added by itself, with other ingredients (optionally as a dry blend) or as part of a masterbatch. In one embodiment, the electrically conductive filler can be part of a masterbatch comprising polyamide. The electrically conductive filler (independently or as a masterbatch) may be added with the poly(arylene ether), with the polyamide (the second portion when two portions are employed), or after the addition of the polyamide (the second portion when two portions are employed).

In one embodiment, the composition comprises the reaction product of poly(arylene ether); polyamide; electrically conductive filler; compatibilizing agent; and impact modifier. As used herein a reaction product is defined as the product resulting from the reaction of two or more of the foregoing components under the conditions employed to form the composition, for example during compounding or high shear mixing.

In one embodiment, the composition, comprises 30 wt. % to 38 wt. % poly(arylene ether); 45 wt. % to 55 wt. % polyamide; 10 wt. % to 15 wt. % impact modifier; 0.5 wt. % to 2 wt. % electrically conductive filler; and 0.0025 wt. % to 2 wt. % an additive having greater than or equal to four conjugated double bonds and a melting temperature less than or equal to 400° C., wherein weight percents are based on a total weight of the composition.

After the composition is melt mixed it is typically formed into strands, which are cut to form pellets. The strand diameter and the pellet length are typically chosen to prevent or reduce the production of fines (particles that have a volume less than or equal to 50% of the pellet) and for maximum efficiency in subsequent processing such as profile extrusion. An exemplary pellet length is 1 to 5 millimeters and an exemplary pellet diameter is 1 to 5 millimeters.

The pellets may exhibit hygroscopic properties. Once water is absorbed it may be difficult to remove. Typically drying is employed but extended drying can affect the performance of the composition. Similarly water, above 0.01-0.1%, or, more specifically, 0.02-0.07% moisture by weight, can hinder the use of the composition in some applications. It is advantageous to protect the composition from ambient moisture. In one embodiment the pellets, once cooled to a temperature of 50° C. to 110° C., are packaged in a container comprising a mono-layer of polypropylene resin free of a metal layer wherein the container has a wall thickness of 0.25 millimeters to 0.60 millimeters. The pellets, once cooled to 50° C. to 110° C. can also be packaged in foiled lined containers such as foil lined boxes and foil lined bags.

The composition may be converted to articles using low shear thermoplastic processes such as film and sheet extrusion, profile extrusion, extrusion molding, compression molding and blow molding. Film and sheet extrusion processes may include and are not limited to melt casting, blown film extrusion and calendaring. Co-extrusion and lamination processes may be employed to form composite multi-layer films or sheets. Single or multiple layers of coatings may further be applied to the single or multi-layer substrates to impart additional properties such as scratch resistance, ultra violet light resistance, aesthetic appeal, etc. Coatings may be applied through standard application techniques such as rolling, spraying, dipping, brushing, or flow-coating.

Oriented films may be prepared through blown film extrusion or by stretching cast or calendared films in the vicinity of the thermal deformation temperature using conventional stretching techniques. For instance, a radial stretching pantograph may be employed for multi-axial simultaneous stretching; an x-y direction stretching pantograph can be used to simultaneously or sequentially stretch in the planar x-y directions. Equipment with sequential uniaxial stretching sections can also be used to achieve uniaxial and biaxial stretching, such as a machine equipped with a section of differential speed rolls for stretching in the machine direction and a tenter frame section for stretching in the transverse direction.

The compositions may be converted to multiwall sheet comprising a first sheet having a first side and a second side, wherein the first sheet comprises a thermoplastic polymer, and wherein the first side of the first sheet is disposed upon a first side of a plurality of ribs; and a second sheet having a first side and a second side, wherein the second sheet comprises a thermoplastic polymer, wherein the first side of the second sheet is disposed upon a second side of the plurality of ribs, and wherein the first side of the plurality of ribs is opposed to the second side of the plurality of ribs.

The films and sheets described above may further be thermoplastically processed into shaped articles via forming and molding processes including but not limited to thermoforming, vacuum forming, pressure forming, injection molding and compression molding. Multi-layered shaped articles may also be formed by injection molding a thermoplastic resin onto a single or multi-layer film or sheet substrate as described below:
1. Providing a single or multi-layer thermoplastic substrate having optionally one or more colors on the surface, for instance, using screen printing or a transfer dye
2. Conforming the substrate to a mold configuration such as by forming and trimming a substrate into a three dimensional shape and fitting the substrate into a mold having a surface which matches the three dimensional shape of the substrate.
3. Injecting a thermoplastic resin into the mold cavity behind the substrate to (i) produce a one-piece permanently bonded three- dimensional product or (ii) transfer a pattern or aesthetic effect from a printed substrate to the injected resin and remove the printed substrate, thus imparting the aesthetic effect to the molded resin.

Those skilled in the art will also appreciate that common curing and surface modification processes including and not limited to heat-setting, texturing, embossing, corona treatment, flame treatment, plasma treatment and vacuum deposition may further be applied to the above articles to alter surface appearances and impart additional functionalities to the articles.

Accordingly, another embodiment relates to articles, sheets and films prepared from the compositions above.

Exemplary articles include all or portions of the following articles: furniture, partitions, containers, vehicle interiors including rail cars, subway cars, busses, trolley cars, airplanes, automobiles, and recreational vehicles, exterior vehicle accessories such as roof rails, appliances, cookware, electronics, analytical equipment, window frames, wire conduit, flooring, infant furniture and equipment, telecommunications equipment, antistatic packaging for electronics equipment and parts, health care articles such as hospital beds and dentist chairs, exercise equipment, motor covers, display covers, business equipment parts and covers, light covers, signage, air handling equipment and covers, automotive underhood parts.

The following non-limiting examples further illustrate the various embodiments described herein.

### EXAMPLES

A list of components of the composition and their suppliers were as indicated in Table 1. All compositions in the examples included standard stabilizers. The amounts shown in the Tables 3-7 are in weight percent with respect to the total weight of the composition. The test methods used for material properties were as summarized in Table 2.

The compositions discussed below were melt mixed in a twin-screw extruder. The extruder was set with barrel temperatures between 270° C. and 310° C. The material was run at 10 kilograms per hour (kg/hr) to 20 kg/hr with the screw rotating at 400 rotations per minute (rpm) to 800 rpm. The additive having greater than or equal to four conjugated double bonds and a melting temperature less than or equal to 400° C. was either added in the main feed with the PAE mixture, or downstream with the polyamides in a masterbatch form, or even mixed with the conductive filler and added from down-down stream in the extruder in a powdered form.

Specific volume resistivity (SVR) was determined by as follows. A tensile bar was molded according to ISO 3167. A sharp, shallow cut was made near each end of the narrow central portion of the bar. The bar was fractured in a brittle fashion at each cut to separate the narrow central portion, now having fractured ends with dimensions of 10 mm×4 mm. If necessary to obtain fracturing in a brittle fashion, the tensile bar was first cooled, for example, in dry ice or liquid nitrogen in a −40° C. freezer. The length of the bar between the fractured ends was measured. The fractured ends of the sample were painted with conductive silver paint, and the paint was allowed to dry. Using a multi-meter such as a Fluke 187, True RMS Multimeter in resistance mode, electrodes were attached to each of the painted surfaces, and the resistance was measured at an applied voltage of 500 millivolts to 1000 millivolts. Values of the specific volume resistivity were obtained by multiplying the measured resistance by the fracture area of one side of the bar and dividing by the length:
ρ=R×A/L

where ρ is the specific volume resistivity in ohm-cm, R is the measured resistance in Ohms, A is the fractured area in square centimeters (cm²), and L is the sample length in centimeters (cm). The specific volume resistivity values have units of Ohm.cm.

TABLE 1

| Component | Trade name/Supplier |
|---|---|
| PPO 803 | Poly(2,6-dimethylphenylene ether) was obtained |
| | from GE Advanced Materials, Plastics and had a |
| | weight average molecular weight (Mw) of 44,000 |
| | and an intrinsic viscosity of 0.4 deciliters per gram |
| | (dl/g) measured in chloroform at 23° C. |
| High heat PPO | Polyphenylene ether (PPE) was obtained from GE |
| | Advanced Materials, Plastics, comprising 2,6- |
| | dimethyl-1,4-phenylene ether units optionally in |
| | combination with 2,3,6-trimethyl-1,4-phenylene |
| | ether units having weight average molecular |
| | weight (Mw) of 40,000 to 45,000 and an intrinsic |
| | viscosity of 0.41 deciliters per gram (dl/g) |
| | measured in chloroform at 23° C. |
| Polyamide | Nylon 6 available as Technyl ASN27/32-35 lc |
| | from Rhodia; Nylon 6,6 available as from Rhodia |
| | having weight average molecular weight (Mw) of |
| | 69,000 and a viscosity number ISO 307 (Vz) of |
| | 126 ml/g. |
| First Impact Modifier (Polystyrene-poly(ethylene | Available as KRATON ® G1651E from Shell |
| butylene)-Polystyrene block copolymer (SEBS)) | Nederland BV and had an Mw of 267,500. |
| Second Impact Modifier (Polystyrene- | Available as KRATON ® G1701E from Shell |
| poly(ethylene propylene) block copolymer (SEP)) | Nederland BV and had an Mw of 152,400. |
| Compatibilizer (Citric acid) | Citric acid available from SD Fine Chem Ltd. |
| Conductive carbon black (CCB) | Ketjen black EC 600JD/Akzo Nobel |
| Stabilizers | IRGANOX 1076 Ciba Specialty Chemicals; |
| | IRGANOX 1010 Ciba Specialty Chemicals; |
| | IRGANOX 1098 Ciba Specialty Chemical. |
| Pyrene | Melting point = 150-155° C.; Boiling point = 404° C.; |
| | CAS No. 129-00-0; available from Sigma Aldrich |
| Methylene Blue | CAS No. 7220-79-3 (trihydrate), 61-73-4 |
| | (anhydrous); available from Sigma Aldrich |
| Anthracene | Melting point = 216-218° C.; Boiling point = 340° C.; |
| | CAS No. 120-12-7; available from Sigma Aldrich |
| Phthalocyanine | CAS No. 574-93-6; available from Sigma |
| | Aldrich |
| Perylene dianhydride | Melting point = 350° C.; CAS No. 128-69-8; |
| | available from Sigma Aldrich |
| C.I. Solvent Orange 60 | Melting point = 230-232° C.; CAS No. 61969-47-9 |
| | available from Jiangsu Aolunda Chemical Co. |
| | China |
| C.I. Solvent Red 52 | Melting point = 274° C.; CAS No. 81-39-0; |
| | available from Jiangsu Aolunda Chemical Co. |
| | China |
| C.I. Solvent Violet 13 | Melting point = 142-143° C.; CAS No. 81-48-1; |
| | available from Jiangsu Aolunda Chemical Co. |
| | China |
| C.I. Solvent Green 3 | Melting point = 220-221° C.; CAS No. 128-80-3; |
| | available from Jiangsu Aolunda Chemical Co. |
| | China |
| C.I. Solvent Orange 63 | Melting point = 314° C.; CAS No. 16294-75-0; |
| | available from Jiangsu Aolunda Chemical Co. |
| | China |
| Phthalo Blue (Copper Phthalocyanine) | Melting point = 600° C.; CAS No. 147-14-8; |
| | available from Sigma Aldrich |

TABLE 2

| Test | | Machine/ |
|---|---|---|
| Method | Material Property | Instrument |
| ISO 527 | Elongation @ break | Instron 5566 |
| ISO | Notched Izod Impact (2 mm notch on a 4 mm | CEAST |
| 180/1A | side of a 4 × 10 × 80 mm sample) | Izod Tester |
| | (hammer weight of 5.5 J is used | |
| ISO 306 | Vicat Softening Temperature in units of | CEAST VST |
| | degrees Celsius (Vicat B/50 on flatwise | |
| | sample placement and deflection of 1 mm | |
| | depth) | |
| ISO 1133 | Melt flow Index (@280° C. under 5 kg load | CEAST MFI |
| | with a pre heating time of 300 seconds @ 0 N | |
| | load | |

TABLE 3

| | Comp. | | | | | | Comp. |
|---|---|---|---|---|---|---|---|
| Composition | Ex. 1 | Ex. 1 | Ex. 2 | Ex. 3 | Ex. 4 | Ex. 5 | Ex. 2 |
| PPO 803 | 34.1 | 34.1 | 34.1 | 34.1 | 34.1 | 34.1 | 34.1 |
| SEP | 8 | 8 | 8 | 8 | 8 | 8 | 8 |
| SEBS | 7 | 7 | 7 | 7 | 7 | 7 | 7 |
| Citric Acid | 0.7 | 0.7 | 0.7 | 0.7 | 0.7 | 0.7 | 0.7 |
| Irganox 1076 | 0.3 | 0.3 | 0.3 | 0.3 | 0.3 | 0.3 | 0.3 |
| KI.H20 | 0.1 | 0.1 | 0.1 | 0.1 | 0.1 | 0.1 | 0.1 |
| CuI | 0.01 | 0.01 | 0.01 | 0.01 | 0.01 | 0.01 | 0.01 |
| PA 6.6 | 38 | 38.3 | 38.1 | 38.15 | 38.05 | 38 | 38.3 |
| PA 6 | 10 | 10 | 10 | 10 | 10 | 10 | 10 |
| Conductive | 1.8 | 1.2 | 1.4 | 1.2 | 1.3 | 1.2 | 1.2 |
| Carbon black | | | | | | | |
| Pyrene | 0 | 0.3 | 0.3 | 0.45 | 0.45 | 0.6 | 0.0 |
| Notched | 15.6 | 46.4 | 22.4 | 49.6 | 46 | 46.8 | 42.0 |
| Izod @ RT | | | | | | | |
| (kJ/m2) | | | | | | | |
| SVR(kOhm · | 0.9 | ** | 4.9 | 529 | 10.8 | 7.8 | ** |
| cm) | | | | | | | |

** >10⁶ Ohm cm

As can be seen in Table 3, increasing amounts of pyrene (Ex. 1, Ex. 3, and Ex. 5) results in a decrease in the SVR while the notched Izod strength remains fairly constant, indicating that conductivity can be increased without sacrificing notched Izod strength. In addition, while the SVR values of Examples 2-5 are beginning to approach the SVR value of Comparative Example 1, which has significantly more conductive filler, the Notched Izod values of Examples 1-5 are significantly higher than the notched Izod value of Comparative Example 1.

TABLE 4

| | | | | | Ex. | Ex. | Ex. | Ex. | Ex. | Com. |
|---|---|---|---|---|---|---|---|---|---|---|
| Composition | Ex. 6 | Ex. 7 | Ex. 8 | Ex. 9 | 10 | 11 | 12 | 13 | 14 | Ex. 3 |
| PPO 803 | 34.1 | 34.1 | 34.1 | 34.1 | 34.1 | 34.1 | 34.1 | 34.1 | 34.1 | 34.1 |
| SEP | 8 | 8 | 8 | 8 | 8 | 8 | 8 | 8 | 8 | 8 |
| SEBS | 7 | 7 | 7 | 7 | 7 | 7 | 7 | 7 | 7 | 7 |
| Citric Acid | 0.7 | 0.7 | 0.7 | 0.7 | 0.7 | 0.7 | 0.7 | 0.7 | 0.7 | 0.7 |
| PA 6.6 | 38.2 | 38 | 37.95 | 37.5 | 37.85 | 37.6 | 37.7 | 37.4 | 37.7 | 37.8 |
| PA 6 | 10 | 10 | 10 | 10 | 10 | 10 | 10 | 10 | 10 | 10 |
| Conductive | 1.44 | 1.2 | 1.4 | 1.2 | 1.2 | 1.2 | 1.2 | 1.2 | 1.2 | 1.4 |
| Carbon black | | | | | | | | | | |
| Methylene | 0.16 | 0 | 0 | 0 | 0 | 0 | 0 | 0 | 0 | 0 |
| blue | | | | | | | | | | |
| Anthracene | 0 | 0.6 | 0 | 0 | 0 | 0 | 0 | 0 | 0 | 0 |
| Pthalocyanine | 0 | 0 | 0.45 | 0 | 0 | 0 | 0 | 0 | 0 | 0 |
| Perylene | 0 | 0 | 0 | 1.1 | 0 | 0 | 0 | 0 | 0 | 0 |
| dianhydride | | | | | | | | | | |
| C.I. Solvent | 0 | 0 | 0 | 0 | 0.75 | 0 | 0 | 0 | 0 | 0 |
| Orange 60 | | | | | | | | | | |
| C.I. Solvent | 0 | 0 | 0 | 0 | 0 | 1 | 0 | 0 | 0 | 0 |
| Red 52 | | | | | | | | | | |
| C.I. Solvent | 0 | 0 | 0 | 0 | 0 | 0 | 0.9 | 0 | 0 | 0 |
| Violet 13 | | | | | | | | | | |
| C.I. Solvent | 0 | 0 | 0 | 0 | 0 | 0 | 0 | 1.2 | 0 | 0 |
| Green 3 | | | | | | | | | | |
| C.I. Solvent | 0 | 0 | 0 | 0 | 0 | 0 | 0 | 0 | 0.9 | 0 |
| Orange 63 | | | | | | | | | | |
| Phthaloblue* | 0 | 0 | 0 | 0 | 0 | 0 | 0 | 0 | 0 | 0.6 |
| Notched Izod | 16.7 | 17.6 | 27.4 | 38.6 | 41.4 | 21.6 | 17.1 | 14.5 | 28.8 | 15 |
| @ RT | | | | | | | | | | |
| (kJ/m2) | | | | | | | | | | |
| SVR(kOhm · cm) | 22 | 50.8 | 103.3 | 34.8 | 103 | 33.4 | 15.2 | 3.3 | 1.5 | 0.390 |

*Copper phthalocyanine
**>10⁶ Ohm cm

As can be seen in Table 4, the synergist effects of adding an additive having greater than or equal to four conjugated double bonds and a melting temperature less than or equal to 400° C. were not limited to pyrene. Rather, compositions comprising methylene blue, anthracene, pthalocyanine, perylene dianhydride, C.I. solvent orange 60, C.I. solvent red 52, C.I. solvent violet 13, C.I. solvent green 3, and C.I. solvent orange 63, demonstrate SVR and Notched Izod values that are comparable to Examples 1-5. Comparative Example 3 employs an additive with a melting temperature greater than 400° C. Comparative Example 3 shows a high conductivity (low resistivity) but has a lower impact strength (Notched Izod) than compositions having comparable levels of additives having a melt temperature less than 400° C.

TABLE 5

| | Comp. | Ex. | Comp. | Ex. |
|---|---|---|---|---|
| Composition | Ex. 4 | 15 | Ex. 5 | 16 |
| PPO 803 | 34.1 | 34.1 | 34.1 | 34.1 |
| SEP | 8 | 8 | 8 | 8 |
| SEBS | 7 | 7 | 7 | 7 |
| Citric Acid | 0.7 | 0.7 | 0.7 | 0.7 |
| Irganox 1076 | 0.3 | 0.3 | 0.3 | 0.3 |
| KI.H20 | 0.1 | 0.1 | 0.1 | 0.1 |
| CuI | 0.01 | 0.01 | 0.01 | 0.01 |
| PA 6.6 | 23 | 22.8 | 23 | 22.8 |
| PA 6 | 10 | 10 | 10 | 10 |
| Conductive Carbon black | 1.8 | 1.2 | 1.8 | 1.2 |
| (ketjen black) | | | | |
| Pyrene | 0 | 0.8 | 0 | 0.8 |
| Mica (60 micrometer) | 15 | 15 | 0 | 0 |
| Glass fiber (amino silane | 0 | 0 | 15 | 15 |
| coated (6 micrometer diameter | | | | |
| and 10-12 millimeters long) | | | | |
| Notched Izod @ RT (kJ/m2) | 7.2 | 8.5 | 12.8 | 11.8 |
| SVR(kOhm · cm) | 2.8 | 5.8 | 8 | 4 |
| Linear coefficient of thermal | 6.7 | 7 | 6.2 | 6.3 |
| expansion (in flow direction) | | | | |
| 23° C.-60° C. (×10⁻⁵ mm/mm/° C.) | | | | |

** >10⁶ Ohm cm

As can be seen in Table 5, the compositions comprising pyrene have SVR and Notched Izod values that are similar to the SVR and Notched Izod values of compositions without pyrene. However, a slight increase in the linear coefficient of thermal expansion (CTE) was noted with the addition of the pyrene along with these fillers. Furthermore, the SVR values are achieve using substantially less carbon black.

TABLE 6

| | Com. | Ex. | Ex. |
|---|---|---|---|
| Composition | Ex. 6 | 17 | 18 |
| PPO 803 | 1.6 | 1.6 | 0.6 |
| High heat PPO | 33.5 | 33.5 | 33.5 |
| SEP | 7.0 | 7.0 | 5.0 |
| SEBS | 7.0 | 7.0 | 5.0 |
| PA 6.6 | 38 | 38 | 38 |
| PA 6 | 10 | 10 | 10 |
| Conductive Carbon black | 1.7 | 1.2 | 1.2 |
| Pyrene | 0 | 0.6 | 0.6 |
| Notched Izod @ RT | 21.9 | 42.6 | 18.4 |
| (kJ/m2) | | | |
| SVR(kOhm · cm) | 5.2 | 7.8 | 15.6 |
| Vicat Softening Temp (° C.) | 182.3 | 184.0 | 193 |
| Melt flow index (g/10 min) | 2.1 | 6.0 | 4.5 |
| (@ 280° C./5 kg) | | | |

As can be seen in the Examples shown in Table 6, similar results are obtained when a mixture of poly(arylene ether)s is used.

TABLE 7

| | Ex. | Ex. | Ex. |
|---|---|---|---|
| Composition | 19 | 20 | 21 |
| PPO 803 (PAE) | 34.1 | 34.1 | 34.1 |
| SEP | 8 | 8 | 8 |
| SEBS | 7 | 7 | 7 |
| PA 6.6 | 37.8 | 37.8 | 37.8 |
| PA 6 | 10 | 10 | 10 |
| Conductive Carbon black | 2 | 2 | 2 |
| Pyrene (Location added: | 0.8 | 0 | 0 |
| Main feed) | | | |
| Pyrene (Location added: | 0 | 0.8 | 0 |
| downstream with | | | |
| polyamide) | | | |
| Pyrene (Location added: | 0 | 0 | 0.8 |
| down down stream with | | | |
| conductive carbon black- | | | |
| after polyamide) | | | |
| Notched Izod @ RT | 41.5 | 33.8 | 46.7 |
| (kJ/m2) | | | |
| SVR(kOhm · cm) | 19.9 | 58.2 | 7.8 |
| Elongation at break (%) | 47.3 | 43.9 | 51.0 |
| Vicat Softening Temp (° C.) | 170 | 176 | 168 |
| Melt flow index (g/10 min) | 13.3 | 13.1 | 8.3 |
| (@ 280° C./5 kg) | | | |

In Table 7, the location of the pyrene addition was varied.

While the invention has been described with reference to exemplary embodiments, it will be understood by those skilled in the art that various changes can be made and equivalents can be substituted for elements thereof without departing from the scope of the invention. In addition, many modifications can be made to adapt a particular situation or material to the teachings of the invention without departing from the invention scope thereof. It is, therefore intended that the invention not be limited to the particular embodiment disclosed as the best mode contemplated for carrying out this invention, but that the invention will include all embodiments falling within the scope of appended claims.

What is claimed is:

1. A resin composition, comprising:
a poly(arylene ether);
a polyamide;
an impact modifier;
an electrically conductive filler; and
an additive wherein the additive has greater than or equal to four conjugated double bonds and a melting temperature less than or equal to 400° C.

2. The resin composition of claim 1, wherein the conjugated double bonds are carbon-to-carbon bonds.

3. The resin composition of claim 1, wherein the additive is selected from the group consisting of phthalocyanines, porphyrins, pyrenes, anthracenes, C.I. Solvent Orange 63, C.I. Solvent Green 3, C.I. Solvent Violet 13, C.I. Solvent Red 52, C.I. Solvent Orange 60, perylene dianhydride, and combinations comprising one or more of the foregoing compounds.

4. The resin composition of claim 3, wherein the additive is pyrene.

5. The resin composition of claim 1, wherein the additive is present in amount of 0.0025 weight percent to 5 weight percent, based on a total weight of the resin.

6. The resin composition of claim 1, wherein in the polyamide is selected from the group consisting of nylon-6; nylon-6,6; and combinations of the foregoing.

7. The resin composition of claim 1, wherein the composition has a specific volume resistivity less than or equal to 10⁶ ohm-cm.

8. The resin composition of claim 7, wherein the specific volume resistivity is less than or equal to 10⁵ ohm-cm.

9. The resin composition of claim 7, wherein the specific volume resistivity is less than or equal to 10⁴ ohm-cm.

10. The resin composition of claim 1, wherein the resin composition has a notched Izod impact at room temperature greater than or equal to 17 kJ/m².

11. The resin composition of claim 10, the resin composition has a notched Izod impact at room temperature greater than or equal to 25 kJ/m².

12. The resin composition of claim 1, wherein the composition has a coefficient of thermal expansion (CTE) of 3×10⁻⁵ mm/mm/° C. to 10×10⁻⁵ mm/mm/° C.

13. The resin composition of claim 1, wherein the composition has a melt index of greater than or equal to 6 g/10 min.

14. An article made from the composition of claim 1.

15. A resin composition of claim 1 wherein the composition comprises:
30 weight percent to 38 weight percent of a poly(arylene ether);
45 weight percent to 55 weight percent of a polyamide;
10 weight percent to 15 weight percent of an impact modifier;
0.5 weight percent to 2 weight percent of an electrically conductive filler; and
0.0025 weight percent to 2 weight percent of an additive wherein the additive has greater than or equal to four conjugated double bonds and a melting temperature less than or equal to 400° C., and further wherein weight percents are with respect to the total weight of the composition.

16. The resin composition of claim 15, further comprising 2 wt. % to 20 wt. % reinforcing filler.

17. An article made from the composition of claim 15.

18. A composition comprising the reaction product of:
a poly(arylene ether);
a polyamide;
an impact modifier;
an electrically conductive filler;
a compatibilizing agent and
an additive wherein the additive has greater than or equal to four conjugated double bonds and a melting temperature less than or equal to 400° C.

19. A method of preparing a resin composition comprising:
melt mixing a composition comprising a poly(arylene ether), an impact modifier and a compatibilizing agent to form a first blend;
melt mixing the first blend with a mixture comprising a polyamide to form a second blend; and
melt mixing the second blend with a mixture comprising a conductive filler; and an additive wherein the additive has greater than or equal to four conjugated double bonds and a melting temperature less than or equal to 400° C.

20. The method of claim 19, wherein the additive is selected from the group consisting of phthalocyanines, porphyrins, pyrenes, anthracenes, and combinations comprising one or more of the foregoing compounds.

21. The method of claim 19, wherein the additive is pyrene.
